(19) United States
(12) Patent Application Publication
(10) Pub. No.: US 2019/0154096 A1
(43) Pub. Date: May 23, 2019

(54) WIRED MATERIAL FOR CANTED COIL SPRING, CANTED COIL SPRING, AND MANUFACTURING METHODS THEREFOR

(71) Applicant: Sumitomo Electric Industries, Ltd., Osaka-shi (JP)

(72) Inventor: Hiromu IZUMIDA, Itami-shi (JP)

(21) Appl. No.: 16/308,674

(22) PCT Filed: Apr. 10, 2017
(86) PCT No.: PCT/JP2017/014666

§ 371 Date: Dec. 10, 2018

(30) Foreign Application Priority Data
Jun. 10, 2016 (JP) 2016-116323

(51) Int. Cl. F16F 1/04; C22C 38/46; C22C 38/22; C22C 38/04; C22C 38/02; C21D 9/52; C21D 6/00; C23C 30/00; B21F 35/00; F16F 1/02

(52) U.S. Cl. CPC F16F 1/045; F16F 2238/026; C22C 38/22; C22C 38/04; C22C 38/02; C21D 9/525; C21D 6/008; C21D 6/005; C21D 6/004; C23C 30/005; B21F 35/00; F16F 1/024; F16F 1/021; F16F 2224/0208; F16F 2226/00; F16F 2226/04; C22C 38/46

(57) ABSTRACT

A wire material for a canted coil spring 1 includes a core wire 10 made of steel with a pearlite structure and a plating layer 20 covering a surface 11 of the core wire 10 and made of copper or a copper alloy. The steel constituting the core wire 10 contains 0.5% to 1.0% by mass of carbon, 0.1% to 2.5% by mass of silicon, and 0.3% to 0.9% by mass of manganese, with the balance being iron and unavoidable impurities.

### TECHNICAL FIELD

The present invention relates to a wire material for a canted coil spring, a canted coil spring, and manufacturing methods therefor.

The present application is based upon and claims the benefit of priority from Japanese Patent Application No. 2016-116323, filed Jun. 10, 2016, the entire contents of which are incorporated herein by reference.

### BACKGROUND ART

Patent Literature 1 describes a canted coil spring, i.e., a helical spring having a structure in which a wire material (metal wire) is wound in an inclined manner with respect to a plane perpendicular to the axial direction. Furthermore, Patent Literature 2 describes a wire material for a canted coil spring in which a core wire made of austenitic stainless steel and a member serving as an outer layer made of copper, a copper alloy, or the like separately prepared are integrated to form a clad wire, and a canted coil spring obtained by coiling the wire material.

### CITATION LIST

### Patent Literature

PTL 1: Japanese Unexamined Patent Application Publication No. 4-107331

PTL 2: Japanese Unexamined Patent Application Publication No. 2012-248495

### SUMMARY OF INVENTION

### Solution to Problem

A wire material for a canted coil spring according to the present disclosure includes a core wire made of steel with a pearlite structure and a plating layer covering a surface of the core wire and made of copper or a copper alloy. The steel contains 0.5% to 1.0% by mass of carbon, 0.1% to 2.5% by mass of silicon, and 0.3% to 0.9% by mass of manganese, with the balance being iron and unavoidable impurities.

A method of manufacturing a wire material for a canted coil spring according to the present disclosure includes a step of preparing a core wire made of steel with a pearlite structure, a step of forming a plating layer made of copper or a copper alloy so as to cover a surface of the core wire, and a step of drawing the core wire provided with the plating layer. The steel contains 0.5% to 1.0% by mass of carbon, 0.1% to 2.5% by mass of silicon, and 0.3% to 0.9% by mass of manganese, with the balance being iron and unavoidable impurities.

### BRIEF DESCRIPTION OF DRAWINGS

FIG. 1 is a schematic cross-sectional view showing a cross section perpendicular to the longitudinal direction of a wire material for a canted coil spring.

FIG. 2 is a schematic view showing a structure of a canted coil spring.

FIG. 3 is a flow chart schematically showing a method of manufacturing a wire material for a canted coil spring and a canted coil spring.

FIG. 4 is a schematic cross-sectional view for describing a method of manufacturing a wire material for a canted coil spring and a canted coil spring.

FIG. 5 is a schematic cross-sectional view for describing a method of manufacturing a wire material for a canted coil spring and a canted coil spring.

### DESCRIPTION OF EMBODIMENTS

### Problems to be Solved by the Present Disclosure

Canted coil springs have a characteristic (nonlinearity) such that the spring load remains substantially constant in relation to the displacement in a direction perpendicular to the axial direction over a certain range of displacement. When a canted coil spring is produced using a conductive material, the canted coil spring can be used, for example, as a contact component. As a material constituting a canted coil spring, beryllium copper is generally employed. From the viewpoint of achieving both strength and conductivity at high levels, beryllium copper is suitable as a material constituting a canted coil spring.

However, beryllium contained in beryllium copper is an expensive material. Furthermore, beryllium is a material having a high environmental load. Therefore, as a material constituting a canted coil spring, development of an alternative material to beryllium copper has been desired.

On the other hand, there is a proposal for a wire material for a canted coil spring in which a core wire made of austenitic stainless steel and a member serving as an outer layer made of copper, a copper alloy, or the like separately prepared are integrated to form a clad wire, and a canted coil spring obtained by coiling the wire material (refer to Patent Literature 2).

The present inventor has studied and found that the canted coil spring according to Patent Literature 2 has a problem in that the range of displacement in which the spring load remains substantially constant in relation to the displacement in a direction perpendicular to the axial direction, i.e., the nonlinear region, is narrow. Accordingly, it is an object to provide a wire material for a canted coil spring and a canted coil spring, each of which is made of an alternative material to beryllium copper and can obtain a wide nonlinear region, and manufacturing methods therefor.

### Advantageous Effects of the Present Disclosure

In the wire material for a canted coil spring and the method of manufacturing a wire material for a canted coil spring, it is possible to provide a wire material for a canted coil spring made of an alternative material to beryllium copper and capable of obtaining a wide nonlinear region.

### Description of Embodiments of the Present Invention

First, the embodiments of the present invention will be described one by one. A wire material for a canted coil spring according to the present application includes a core wire made of steel with a pearlite structure and a plating layer covering a surface of the core wire and made of copper or a copper alloy. The steel contains 0.5% to 1.0% by mass of carbon, 0.1% to 2.5% by mass of silicon, and 0.3% to 0.9% by mass of manganese, with the balance being iron and unavoidable impurities.

In the wire material for a canted coil spring according to the present application, a high strength core wire made of steel having a pearlite structure and an appropriate component composition is used. Thereby, a wide nonlinear region can be secured. Furthermore, the surface of the core wire is covered with a plating layer made of copper or a copper alloy having excellent conductivity. Thereby, high conductivity can be secured. Here, the copper alloy is, for example, an alloy of copper and at least one metal selected from the group consisting of zinc, tin, phosphorus, and iron.

Furthermore, the wire material for a canted coil spring according to the present application is not a clad wire in which a core wire and a member serving as an outer layer separately prepared are integrated, but has a structure in which a plating layer is formed on the surface of a core wire. The present inventor has studied and found that, in a canted coil spring obtained from a clad wire, a phenomenon occurs in which the outer layer slips with respect to the core wire when a load is applied. This phenomenon is a major factor in the narrowing of the nonlinear region. In contrast, in the wire material for a canted coil spring according to the present application in which the plating layer is formed on the surface of the core wire, occurrence of such a phenomenon is suppressed, and it is possible to secure a wide nonlinear region. As described above, in the wire material for a canted coil spring according to the present application, it is possible to provide a wire material for a canted coil spring, which is made of an alternative material to beryllium copper and can obtain a wide nonlinear region.

In the wire material for a canted coil spring, the steel may further contain at least one element selected from the group consisting of 0.1% to 0.4% by mass of nickel, 0.1% to 1.8% by mass of chromium, 0.1% to 0.4% by mass of molybdenum, and 0.05% to 0.3% by mass of vanadium. Even in the case where a core wire made of steel having such a component composition is used, it is possible to provide a wire material for a canted coil spring, which is made of an alternative material to beryllium copper and can obtain a wide nonlinear region.

The reasons for limiting the component composition of the steel constituting the core wire to the ranges described above will be described below.

Carbon (C): 0.5% to 1.0% by Mass

Carbon is an element that greatly influences the strength and elastic limit of steel with a pearlite structure. From the viewpoint of obtaining sufficient strength and elastic limit as a core wire of the wire material for a canted coil spring, the carbon content needs to be 0.5% by mass or more. On the other hand, when the carbon content increases, toughness decreases, and there is a concern that working may become difficult. From the viewpoint of securing sufficient toughness, the carbon content needs to be 1.0% by mass or less. From the viewpoint of further improving strength and elastic limit, the carbon content is preferably 0.6% by mass or more, and more preferably 0.8% by mass or more. From the viewpoint of improving toughness to facilitate working, the carbon content is preferably 0.95% by mass or less.

Silicon (Si): 0.1% to 2.5% by Mass

Silicon is an element that is added as a deoxidizing agent in copper smelting. In order for silicon to function as a deoxidizing agent, the silicon content needs to be 0.1% by mass or more, and is preferably 0.12% by mass or more. Furthermore, silicon functions as a carbide-forming element in steel and has a property of suppressing softening due to heating (softening resistance). From the viewpoint of suppressing softening in the strain relieving heat treatment carried out after the wire material is coiled, the silicon content is preferably 0.8% by mass or more, and may be 1.8% by mass or more. On the other hand, excessive addition of silicon degrades toughness. From the viewpoint of securing sufficient toughness, the silicon content needs to be 2.5% by mass or less, is preferably 2.3% by mass or less, and may be 2.2% by mass or less. From the viewpoint of attaching importance to toughness, the silicon content may be 1.0% by mass or less.

Manganese (Mn): 0.3% to 0.9% by Mass

Manganese is an element that is added as a deoxidizing agent in copper smelting, in a similar manner to silicon. In order for manganese to function as a deoxidizing agent, the manganese content needs to be 0.3% by mass or more. On the other hand, excessive addition of manganese degrades toughness and workability in hot working. Therefore, the manganese content needs to be 0.9% by mass or less.

Unavoidable Impurities

In the manufacturing process of the core wire, phosphorus (P) and sulfur (S) are unavoidably mixed into steel constituting the core wire. Excessive presence of phosphorus and sulfur causes grain boundary segregation and generates inclusions, hence degrading characteristics of steel. Therefore, the phosphorus content and the sulfur content are each preferably 0.025% by mass or less. Furthermore, the total content of unavoidable impurities is preferably 0.3% by mass or less.

Nickel (Ni): 0.1% to 0.4% by Mass

Addition of nickel suppresses occurrence of breakage of the wire during drawing of the core wire and during coiling of the wire material. From the viewpoint of reliably demonstrating this function, nickel may be added in an amount of 0.1% by mass or more. However, even if nickel is added in an amount of more than 0.4% by mass, the effect of nickel is saturated. Furthermore, when nickel, which is an expensive element, is added in an amount of more than 0.4% by mass, the manufacturing cost of the core wire increases. Therefore, the amount of nickel added is preferably 0.4% by mass or less.

Chromium (Cr): 0.1% to 1.8% by Mass

Chromium functions as a carbide-forming element in steel and contributes to refining the metal structure by formation of fine carbides and suppressing softening during heating. From the viewpoint of reliably demonstrating such effects, chromium may be added in an amount of 0.1% by mass or more, or may be added in an amount of 0.2% by mass or more, or 0.5% by mass or more. However, excessive addition of chromium causes degradation in toughness. Therefore, the amount of chromium added is preferably 1.8% by mass or less. The effects by the addition of chromium become particularly marked under coexistence of silicon and vanadium. Therefore, chromium is preferably added together with these elements.

Molybdenum (Mo): 0.1% to 0.4% by Mass

Addition of molybdenum can increase the elastic limit. From the viewpoint of reliably demonstrating this function, molybdenum may be added in an amount of 0.1% by mass or more. However, even if molybdenum is added in an amount of more than 0.4% by mass, the effect of molybdenum is saturated. Furthermore, when molybdenum, which is an expensive element, is added in an amount of more than 0.4% by mass, the manufacturing cost of the core wire increases. Therefore, the amount of molybdenum added is preferably 0.4% by mass or less.

Vanadium (V): 0.05% to 0.3% by Mass

Vanadium functions as a carbide-forming element in steel and contributes to refining the metal structure by formation of fine carbides and suppressing softening during heating. From the viewpoint of reliably demonstrating such effects, vanadium may be added in an amount of 0.05% by mass or more. However, excessive addition of vanadium causes degradation in toughness. From the viewpoint of securing sufficient toughness, the amount of vanadium added is preferably 0.3% by mass or less. The effects by the addition of vanadium become particularly marked under coexistence of silicon and chromium. Therefore, vanadium is preferably added together with these elements.

In the wire material for a canted coil spring, the silicon content in the steel may be 1.35% to 2.3% by mass. When the silicon content is 1.35% by mass or more, it is possible to suppress softening in the strain relieving heat treatment. When the silicon content is 2.3% by mass or less, degradation in toughness can be suppressed.

In the wire material for a canted coil spring, the steel may contain 0.6% to 1.0% by mass of carbon, 0.12% to 0.32% by mass of silicon, and 0.3% to 0.9% by mass of manganese, with the balance being iron and unavoidable impurities.

Furthermore, in the wire material for a canted coil spring, the steel may contain 0.6% to 1.0% by mass of carbon, 0.7% to 1.0% by mass of silicon, and 0.3% to 0.9% by mass of manganese, with the balance being iron and unavoidable impurities.

Furthermore, in the wire material for a canted coil spring, the steel may contain 0.55% to 0.7% by mass of carbon, 1.35% to 2.3% by mass of silicon, 0.3% to 0.9% by mass of manganese, 0.2% to 1.8% by mass of chromium, and 0.05% to 0.30% by mass of vanadium, with the balance being iron and unavoidable impurities.

By using steel having such a component composition as the steel constituting the core wire, a wide nonlinear region can be obtained more reliably.

In the wire material for a canted coil spring, the oxygen concentration at the interface between the core wire and the plating layer may be 10% by mass or less. In such a manner, a wide nonlinear region can be obtained more reliably.

The wire material for a canted coil spring may have a tensile strength of 1,800 to 2,500 MPa. By setting the tensile strength at 1,800 MPa or more, a wide nonlinear region can be easily obtained. By setting the tensile strength at 2,500 MPa or less, sufficient workability can be secured easily.

The wire material for a canted coil spring may have a conductivity of 15% to 50% IACS (International Annealed Copper Standard). In such a manner, it is possible to obtain a wire material for a canted coil spring that can be used to manufacture a canted coil spring suitable for a contact component.

In the wire material for a canted coil spring, the plating layer may have a thickness of 10 μm to 65 μm. When the thickness of the plating layer is 10 μm or more, sufficient conductivity can be easily obtained. When the thickness of the plating layer is 65 μm or less, high strength and a high elastic limit can be easily obtained. Consequently, a wide nonlinear region can be easily obtained. From the viewpoint of obtaining a wider nonlinear region, the thickness of the plating layer may be 50 μm or less.

In the wire material for a canted coil spring, the core wire may have a diameter of 0.05 mm to 2.0 mm. In such a manner, it is possible to obtain a wire material for a canted coil spring particularly suitable for manufacturing a canted coil spring.

The wire material for a canted coil spring may include at least one of a tin (Sn) plating layer and a silver (Ag) plating layer that covers the surface thereof. In such a manner, when a canted coil spring made from the wire material for a canted coil spring is used as a contact component, such as a conductive connector for electrically connecting electrical wires and electronic devices, contact resistance can be reduced.

A canted coil spring according to the present application is made from the wire material for a canted coil spring. In the canted coil spring according to the present application, which is made from the wire material for a canted coil spring according to the present application, it is possible to provide a canted coil spring which is made of an alternative material to beryllium copper and can obtain a wide nonlinear region.

The canted coil spring may include at least one of a tin plating layer and a silver plating layer that covers the surface thereof. In such a manner, when the canted coil spring is used as a contact component, contact resistance can be reduced.

A method of manufacturing a wire material for a canted coil spring according to the present application includes a step of preparing a core wire made of steel with a pearlite structure, a step of forming a plating layer made of copper or a copper alloy so as to cover a surface of the core wire, and a step of drawing the core wire provided with the plating layer. The steel contains 0.5% to 1.0% by mass of carbon, 0.1% to 2.5% by mass of silicon, and 0.3% to 0.9% by mass of manganese, with the balance being iron and unavoidable impurities.

In the method of manufacturing a wire material for a canted coil spring according to the present application, it is possible to easily manufacture the wire material for a canted coil spring of the present application, which is made of an alternative material to beryllium copper and can obtain a wide nonlinear region.

In the method of manufacturing a wire material for a canted coil spring, the steel may further contain at least one element selected from the group consisting of 0.1% to 0.4% by mass of nickel, 0.1% to 1.8% by mass of chromium, 0.1% to 0.4% by mass of molybdenum, and 0.05% to 0.3% by mass of vanadium. In the case where a core wire made of steel having such a component composition is used, it is also possible to manufacture a wire material for a canted coil spring, which is made of an alternative material to beryllium copper and can obtain a wide nonlinear region.

In the method of manufacturing a wire material for a canted coil spring, the silicon content in the steel may be 1.35% to 2.3% by mass. When the silicon content is 1.35% by mass or more, it is possible to suppress softening in the strain relieving heat treatment carried out after coiling. When the silicon content is 2.3% by mass or less, degradation in toughness can be suppressed.

In the method of manufacturing a wire material for a canted coil spring, the steel may contain 0.6% to 1.0% by mass of carbon, 0.12% to 0.32% by mass of silicon, and 0.3% to 0.9% by mass of manganese, with the balance being iron and unavoidable impurities.

Furthermore, in the method of manufacturing a wire material for a canted coil spring, the steel may contain 0.6% to 1.0% by mass of carbon, 0.7% to 1.0% by mass of silicon, and 0.3% to 0.9% by mass of manganese, with the balance being iron and unavoidable impurities.

Furthermore, in the method of manufacturing a wire material for a canted coil spring, the steel may contain 0.55% to 0.7% by mass of carbon, 1.35% to 2.3% by mass of silicon, 0.3% to 0.9% by mass of manganese, 0.2% to 1.8% by mass of chromium, and 0.05% to 0.30% by mass of vanadium, with the balance being iron and unavoidable impurities.

By using steel having such a component composition as the steel constituting the core wire, a wide nonlinear region can be obtained more reliably.

Furthermore, the method of manufacturing a wire material for a canted coil spring may further include a step of forming at least one of a tin plating layer and a silver plating layer on the plating layer. In such a manner, when a canted coil spring made from the manufactured wire material for a canted coil spring is used as a contact component, such as a conductive connector for electrically connecting electrical wires and electronic devices, contact resistance can be reduced.

A method of manufacturing a canted coil spring according to the present application includes a step of preparing a wire material for a canted coil spring which has been manufactured by the method of manufacturing a wire material for a canted coil spring according to the present application, and a step of coiling the wire material for a canted coil spring.

By manufacturing a canted coil spring by coiling a wire material for a canted coil spring which has been manufactured by the method of manufacturing a wire material for a canted coil spring according to the present application, it is possible to easily manufacture a canted coil spring made of an alternative material to beryllium copper and capable of obtaining a wide nonlinear region.

The method of manufacturing a canted coil spring may further include a step of heating the wire material for a canted coil spring which has been coiled to a temperature range of 250° C. to 400° C. In such a manner, a wider nonlinear region can be obtained.

The method of manufacturing a canted coil spring may further include a step of forming at least one of a tin plating layer and a silver plating layer on the plating layer. In such a manner, when the manufactured canted coil spring is used as a contact component, contact resistance can be reduced.

### Detailed Description of Embodiments of the Present Invention

Embodiments of a wire material for a canted coil spring and a canted coil spring according to the present invention will be described below with reference to the drawings. In the drawings, the same or equivalent components are designated by the same reference numerals, and descriptions thereof are not repeated.

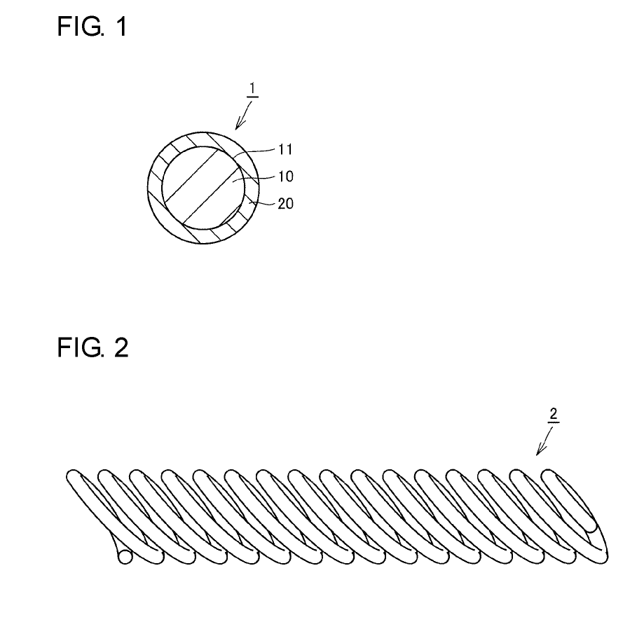

Referring to FIG. 1, a wire material for a canted coil spring 1 according to the embodiment includes a core wire 10 and a plating layer 20. The core wire 10 is made of steel with a pearlite structure. The plating layer 20 covers a surface 11 of the core wire 10. The plating layer 20 is made of copper or a copper alloy. A cross section that is perpendicular to the longitudinal direction of the wire material for a canted coil spring 1 is circular.

The steel constituting the core wire 10 contains 0.5% to 1.0% by mass of carbon, 0.1% to 2.5% by mass of silicon, and 0.3% to 0.9% by mass of manganese, with the balance being iron and unavoidable impurities.

Referring to FIG. 2, a canted coil spring 2 according to the embodiment is made from the wire material for a canted coil spring 1 according to the embodiment. The canted coil spring 2 is a helical spring and has a structure in which the wire material for a canted coil spring 1 is wound in an inclined manner with respect to a plane perpendicular to the axial direction. The canted coil spring 2 is used such that a load is applied in a direction perpendicular to the axial direction.

In the wire material for a canted coil spring 1 and the canted coil spring 2 according to the embodiment, the core wire 10 with high strength, made of steel having a pearlite structure and an appropriate component composition is used. Thereby, a wide nonlinear region can be secured. Furthermore, the surface 11 of the core wire 10 is covered with the plating layer 20 made of copper or a copper alloy having excellent conductivity. Thereby, high conductivity can be secured.

Furthermore, each of the wire material for a canted coil spring 1 and the canted coil spring 2 is not formed of a clad wire in which a core wire and a member serving as an outer layer separately prepared are integrated, but has a structure in which the plating layer 20 is formed on the surface 11 of the core wire 10. Therefore, occurrence of a phenomenon in which the plating layer 20 serving as an outer layer slips with respect to the core wire 10 when a load is applied is suppressed. Consequently, it is possible to secure a wide nonlinear region. As described above, the wire material for a canted coil spring 1 and the canted coil spring 2 according to the embodiment are each made of an alternative material to beryllium copper and can obtain a wide nonlinear region.

In the wire material for a canted coil spring 1 and the canted coil spring 2, the steel constituting the core wire 10 may further contain at least one element selected from the group consisting of 0.1% to 0.4% by mass of nickel, 0.1% to 1.8% by mass of chromium, 0.1% to 0.4% by mass of molybdenum, and 0.05% to 0.3% by mass of vanadium. Even in the case where the core wire 10 made of steel having such a component composition is used, the wire material for a canted coil spring 1 and the canted coil spring 2 are made of an alternative material to beryllium copper, and a wide nonlinear region can be obtained.

In the wire material for a canted coil spring 1 and the canted coil spring 2, the silicon content in the steel constituting the core wire 10 may be 1.35% to 2.3% by mass. When the silicon content is 1.35% by mass or more, it is possible to suppress softening in the strain relieving heat treatment. When the silicon content is 2.3% by mass or less, degradation in toughness can be suppressed.

In the wire material for a canted coil spring 1 and the canted coil spring 2, the steel constituting the core wire 10 may contain 0.6% to 1.0% by mass of carbon, 0.12% to 0.32% by mass of silicon, and 0.3% to 0.9% by mass of manganese, with the balance being iron and unavoidable impurities.

Furthermore, in the wire material for a canted coil spring 1 and the canted coil spring 2, the steel constituting the core wire 10 may contain 0.6% to 1.0% by mass of carbon, 0.7% to 1.0% by mass of silicon, and 0.3% to 0.9% by mass of manganese, with the balance being iron and unavoidable impurities.

Furthermore, in the wire material for a canted coil spring 1 and the canted coil spring 2, the steel constituting the core wire 10 may contain 0.55% to 0.7% by mass of carbon, 1.35% to 2.3% by mass of silicon, 0.3% to 0.9% by mass of manganese, 0.2% to 1.8% by mass of chromium, and 0.05% to 0.30% by mass of vanadium, with the balance being iron and unavoidable impurities.

By using steel having such a component composition as the steel constituting the core wire 10, a wide nonlinear region can be obtained more reliably.

In the wire material for a canted coil spring 1 and the canted coil spring 2, preferably, the oxygen concentration at the interface between the core wire 10 and the plating layer 20 is 10% by mass or less. In such a manner, a wide nonlinear region can be obtained more reliably. Note that, the oxygen concentration at the interface between the core wire 10 and the plating layer 20 can be measured, for example, by performing a quantitative analysis, with EDS (Energy Dispersive X-ray Spectrometry), on a square region with a side of 300 μm including the interface between the core wire 10 and the plating layer 20 in a cross section perpendicular to the longitudinal direction of the wire material for a canted coil spring 1.

Preferably, the wire material for a canted coil spring 1 has a tensile strength of 1,800 to 2,500 MPa. By setting the tensile strength at 1,800 MPa or more, a wide nonlinear region can be easily obtained. By setting the tensile strength at 2,500 MPa or less, sufficient workability can be secured easily.

Preferably, the wire material for a canted coil spring 1 and the canted coil spring 2 have a conductivity of 15% to 50% IACS. Thereby, it is possible to obtain a canted coil spring and a wire material for a canted coil spring that are suitable for a contact component.

In the wire material for a canted coil spring 1 and the canted coil spring 2, preferably, the plating layer 20 has a thickness of 10 μm to 65 μm. When the thickness of the plating layer 20 is 10 μm or more, sufficient conductivity can be easily obtained. When the thickness of the plating layer 20 is 65 μm or less, high strength and a high elastic limit can be easily obtained. Consequently, a wide nonlinear region can be easily obtained.

In the wire material for a canted coil spring 1, preferably, the core wire 10 has a diameter of 0.05 mm to 2.0 mm. Thereby, it is possible to obtain a wire material for a canted coil spring particularly suitable for manufacturing a canted coil spring.

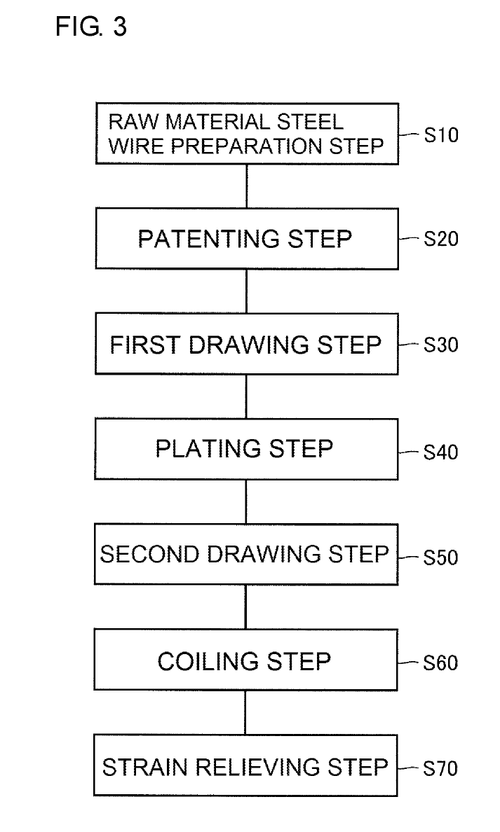

An example of a method of manufacturing a wire material for a canted coil spring 1 and a canted coil spring 2 will be described below. Referring to FIG. 3, in a method of manufacturing a wire material for a canted coil spring 1 and a canted coil spring 2 according to the embodiment, first, a raw material steel wire preparation step (S10) is carried out. In this step (S10), a steel wire serving as a core wire 10 is prepared. Specifically, a steel wire made of steel containing 0.5% to 1.0% by mass of carbon, 0.1% to 2.5% by mass of silicon, and 0.3% to 0.9% by mass of manganese, with the balance being iron and unavoidable impurities is prepared. The steel constituting the steel wire may further contain at least one element selected from the group consisting of 0.1% to 0.4% by mass of nickel, 0.1% to 1.8% by mass of chromium, 0.1% to 0.4% by mass of molybdenum, and 0.05% to 0.3% by mass of vanadium.

Next, a patenting step (S20) is carried out. In this step (S20), the raw material steel wire prepared in the step (S10) is subjected to patenting.

Specifically, a heat treatment is carried out in which the raw material steel wire is heated to a temperature range of the austenitizing temperature (A₁ point) or higher, then rapidly cooled to a temperature range of higher than the martensitic transformation starting temperature (Mₛ point), and held in this temperature range. Thereby, the metal structure of the raw material steel wire is transformed into a fine pearlite structure with small lamellar spacing. In the patenting treatment, the treatment of heating the raw material steel wire to a temperature range of the A₁ point or higher is carried out in an inert gas atmosphere from the viewpoint of suppressing the occurrence of decarburization.

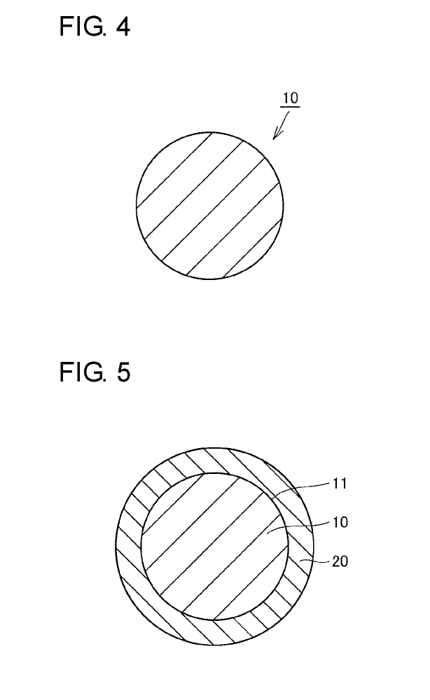

Next, a first drawing step (S30) is carried out. In this step (S30), the raw material steel wire subjected to patenting in the step (S20) is drawn (pulled). Thereby, referring to FIG. 4, a core wire 10 which has a pearlite structure and whose cross section perpendicular to the longitudinal direction is circular is obtained.

Next, a plating step (S40) is carried out. In this step (S40), referring to FIGS. 4 and 5, a plating layer 20 made of copper or a copper alloy is formed so as to cover a surface 11 of the core wire 10 obtained in the step (S30). The plating layer 20 formed in the step (S40) has a thickness of, for example, 30 μm to 90 μm.

Next, a second drawing step (S50) is carried out. In this step (S50), referring to FIGS. 5 and 1, the core wire 10 on which the plating layer 20 has been formed in the step (S40) is drawn. Thereby, a wire material for a canted coil spring 1 having a wire diameter appropriate for an intended canted coil spring 2 is obtained. Through the procedure described above, manufacturing of the wire material for a canted coil spring 1 in the embodiment is completed. A method of manufacturing a canted coil spring 2 by using the wire material for a canted coil spring 1 will be described below.

Next, a coiling step (S60) is carried out. In this step (S60), referring to FIGS. 1 and 2, the wire material for a canted coil spring 1 obtained in the step (S50) is formed into the shape of a canted coil spring 2. Specifically, the wire material for a canted coil spring 1 is helically processed and formed into the shape of a canted coil spring 2.

Next, a strain relieving step (S70) is carried out. In this step (S70), a heat treatment is carried out in which the wire material for a canted coil spring 1 which has been formed into the shape of a canted coil spring 2 in the step (S60) is heated to a temperature range of 250° C. to 400° C. Thereby, the strain introduced into the wire material for a canted coil spring 1 by the process in the step (S60) is relieved. Consequently, a wide nonlinear region can be obtained. Through the procedure described above, manufacturing of the canted coil spring 2 according to the embodiment is completed.

In the method of manufacturing a wire material for a canted coil spring and a canted coil spring according to the embodiment, it is possible to easily manufacture a wire material for a canted coil spring 1 and a canted coil spring 2 according to the embodiment which are made of an alternative material to beryllium copper and capable of obtaining a wide nonlinear region.

In the steel constituting the raw material steel wire prepared in the step (S10), the silicon content may be 1.35% to 2.3% by mass.

Furthermore, the steel constituting the raw material steel wire prepared in the step (S10) may contain 0.6% to 1.0% by mass of carbon, 0.12% to 0.32% by mass of silicon, and 0.3% to 0.9% by mass of manganese, with the balance being iron and unavoidable impurities.

Furthermore, the steel constituting the raw material steel wire prepared in the step (S10) may contain 0.6% to 1.0% by mass of carbon, 0.7% to 1.0% by mass of silicon, and 0.3% to 0.9% by mass of manganese, with the balance being iron and unavoidable impurities.

Furthermore, the steel constituting the raw material steel wire prepared in the step (S10) may contain 0.55% to 0.7% by mass of carbon, 1.35% to 2.3% by mass of silicon, 0.3% to 0.9% by mass of manganese, 0.2% to 1.8% by mass of chromium, and 0.05% to 0.30% by mass of vanadium, with the balance being iron and unavoidable impurities.

By using steel having such a component composition as the steel constituting the core wire, a wide nonlinear region can be obtained more reliably.

### EXAMPLES

### Example 1

An experiment was conducted in which canted coil springs were actually produced using wire materials for a canted coil spring according to the present application, and the conductivity and the width of the nonlinear region were checked. The procedure of the experiment is as follows.

Canted coil springs were produced in accordance with the same procedure as that of the method of manufacturing a canted coil spring 2 described in the above embodiment. The component composition (steel type) of steel wires used as a core wire 10 is shown in Table 1. Note that the balance other than the components shown in Table 1 is iron.

TABLE 1

| | C | Si | Mn | P | S | Ni | Cr | Mo | V |
|---|---|---|---|---|---|---|---|---|---|
| Steel type A | 0.82 | 0.20 | 0.67 | ≤0.025 | ≤0.025 | — | — | — | — |
| Steel type B | 0.82 | 0.80 | 0.67 | ≤0.025 | ≤0.025 | — | — | — | — |
| Steel type C | 0.65 | 2.0 | 0.67 | ≤0.025 | ≤0.025 | — | 0.70 | — | 0.10 |
| Steel type D | 0.65 | 2.0 | 0.67 | ≤0.025 | ≤0.025 | — | 1.8 | — | 0.10 |
| Steel type E | 0.65 | 2.0 | 0.67 | ≤0.025 | ≤0.025 | — | 1.8 | — | 0.30 |
| Steel type F | 0.65 | 2.0 | 0.67 | ≤0.025 | ≤0.025 | 0.30 | 0.70 | — | 0.10 |
| Steel type G | 0.65 | 2.0 | 0.67 | ≤0.025 | ≤0.025 | — | 0.70 | 0.20 | 0.10 |

Referring to Table 1, a piano wire (steel type A in Table 1), a piano wire in which the silicon content was increased (steel type B in Table 1), and a piano wire in which the carbon content was decreased, the silicon content was increased, and chromium and vanadium were further added (steel type C in Table 1) were each used as a core wire 10. A plating layer 20 made of copper, with a thickness of 30 μm, was formed so as to cover the surface 11 of the core wire 10. The wire diameter of a wire material for a canted coil spring 1 was set at 0.60 mm. The wire material for a canted coil spring 1 was formed into a canted coil spring 2. The canted coil spring 2 had a structure in which the planar shape viewed from an end face side in the axial direction was elliptical with a major axis of 5.4 mm and a minor axis of 5.0 mm, the length in the axial direction (natural length of the spring) was 45 mm, and the total number of coils was 50 (Examples A, B, and C). For comparison, a canted coil spring having the same structure was prepared by using a clad wire including a core wire made of austenitic stainless steel and an outer layer made of copper (Comparative Example A), and a canted coil spring having the same structure was prepared by using a wire material made of beryllium copper (Comparative Example B). Regarding every canted coil spring, after being formed into the shape of a spring, a strain relieving heat treatment was carried out in which the spring was heated to 250° C. and held for 30 minutes.

Regarding Examples A to C and Comparative Examples A and B, the conductivity and the maximum value of displacement at which the change in the load applied in a direction perpendicular to the axial direction was 20 N or less (length of the nonlinear region) were measured. The experimental results are shown in Table 2.

TABLE 2

| | | | Tensile strength | | Length of |
|---|---|---|---|---|---|
| | | Outer | of wire material | Conductivity | nonlinear region |
| | Core wire | layer | for spring (MPa) | (% IACS) | (mm) |
| Example A | Steel type A | Copper plating | 2280 | 31 | 0.63 |
| Example B | Steel type B | Copper plating | 2356 | 34 | 0.68 |
| Example C | Steel type C | Copper plating | 2324 | 32 | 0.82 |
| Comparative | Stainless steel wire | Copper-clad | 1752 | 31 | 0.50 |
| Example A | | | | | |
| Comparative | Beryllium copper wire | — | 1523 | 16 | 0.53 |
| Example B | | | | | |

Referring to Table 2, in each of Examples A to C which are canted coil springs according to the present application, while maintaining a conductivity equal to or higher than that of Comparative Example A and higher than that of Comparative Example B, a wider nonlinear region than that of Comparative Example A or B is achieved. This confirms that, in the wire material for a canted coil spring and the canted coil spring according to the present application, which are made of an alternative material to beryllium copper, it is possible to obtain a wide nonlinear region. In particular, in Example B in which the silicon content in the steel constituting the core wire is high and Example C in which chromium and vanadium are further added, a much wider nonlinear region is obtained. The reason for this is believed to be that by adding silicon, chromium, and the like which improve softening resistance during heating of the steel, dislocation can be reduced by the strain relieving heat treatment while maintaining a high elastic limit.

### Example 2

An experiment was conducted in order to investigate the influence of the composition of steel constituting core wires (steel type) on the characteristics of canted coil springs. Specifically, referring to Table 1, a canted coil spring having the same structure as that in Example 1 in which steel type C was used as the steel type constituting the core wire (Example C), a canted coil spring using steel type D which was the same as steel type C except that the chromium content was increased (Example D), a canted coil spring using Steel type E which was the same as steel type C except that the chromium content and the vanadium content were increased (Example E), a canted coil spring using steel type F which was the same as steel type C except that nickel was added (Example F), and a canted coil spring using steel type G which was the same as steel type C except that molybdenum was added (Example G) were prepared. An experiment for evaluating characteristics was conducted as in Example 1. The experimental results are shown in Table 3.

TABLE 3

| | | | Tensile strength | | Length of |
|---|---|---|---|---|---|
| | | Outer | of wire material | Conductivity | nonlinear region |
| | Core wire | layer | for spring (MPa) | (% IACS) | (mm) |
| Example C | Steel type C | Copper plating | 2324 | 32 | 0.82 |
| Example D | Steel type D | Copper plating | 2351 | 31 | 0.85 |
| Example E | Steel type E | Copper plating | 2348 | 32 | 0.89 |
| Example F | Steel type F | Copper plating | 2313 | 32 | 0.81 |
| Example G | Steel type G | Copper plating | 2335 | 32 | 0.87 |

Referring to Table 3, it is evident that by increasing the amounts of chromium and vanadium which improve softening resistance during heating of the steel (Examples D and E), a much wider nonlinear region can be obtained. The reason for this is believed to be that dislocation can be reduced by the strain relieving heat treatment while maintaining a high elastic limit. Furthermore, in the case where nickel is added (Example F), characteristics that compare favorably with Example C which does not include nickel are obtained. Addition of nickel suppresses occurrence of breakage of the wire during drawing of the core wire and during coiling of the wire material. That is, by adding nickel, workability can be improved without greatly affecting the characteristics. Furthermore, it is evident that by adding molybdenum (Example G), a much wider nonlinear region can be obtained. The reason for this is believed to be that by adding molybdenum, a high elastic limit can be obtained.

### Example 3

An experiment was conducted in order to investigate the influence of the strain relieving heat treatment temperature on the characteristics of canted coil springs. Specifically, in Examples A, B, and C of Example 1, the heating temperature in the strain relieving heat treatment was changed to 300° C. (Examples A1, B1, and C1), changed to 350° C. (Examples A2, B2, and C2), and changed to 400° C. (Examples A3, B3, and C3). An experiment for evaluating characteristics was conducted on these examples as in Example 1. The heating time in the strain relieving heat treatment was 30 minutes as in Example 1. The experimental results are shown in Table 4.

TABLE 4

| | | | Tensile strength | | Length of |
|---|---|---|---|---|---|
| | | Outer | of wire material | Conductivity | nonlinear region |
| | Core wire | layer | for spring (MPa) | (% IACS) | (mm) |
| Example A | Steel type A | Copper plating | 2280 | 31 | 0.63 |
| Example A1 | Steel type A | Copper plating | 2278 | 31 | 0.64 |
| Example A2 | Steel type A | Copper plating | 2133 | 32 | 0.62 |
| Example A3 | Steel type A | Copper plating | 2010 | 32 | 0.60 |
| Example B | Steel type B | Copper plating | 2356 | 34 | 0.68 |
| Example B1 | Steel type B | Copper plating | 2367 | 35 | 0.68 |
| Example B2 | Steel type B | Copper plating | 2398 | 35 | 0.70 |
| Example B3 | Steel type B | Copper plating | 2345 | 35 | 0.68 |
| Example C | Steel type C | Copper plating | 2324 | 32 | 0.82 |
| Example C1 | Steel type C | Copper plating | 2355 | 32 | 0.81 |
| Example C2 | Steel type C | Copper plating | 2323 | 33 | 0.84 |
| Example C3 | Steel type C | Copper plating | 2298 | 33 | 0.79 |

Referring to Table 4, in the case where the core wire with any one of the component compositions is used, the heat treatment temperature at which the width of the nonlinear region becomes maximum lies in a temperature range of 250° C. to 400° C. This confirms that it is preferable to set the heating temperature in the strain relieving heat treatment at 250° C. to 400° C. Note that the holding time during heating in the strain relieving heat treatment is preferably 20 to 60 minutes.

### Example 4

An experiment was conducted in order to investigate the influences of the mechanical property of the material and conductivity on the characteristics of canted coil springs. Specifically, referring to Table 1, a canted coil spring having the same structure as that in Example 1 in which steel type A was used as the steel type constituting the core wire (Example A), a canted coil spring in which a core wire made of steel type A was used, and by adjusting the thickness of copper plating and the drawing reduction of area, the conductivity was set at about 15% (Example H), and a canted coil spring in which a core wire made of steel type A was used, and similarly, by adjusting the thickness of copper plating and the drawing reduction of area, the conductivity was set at about 50% (Example I) were prepared. An experiment for evaluating characteristics was conducted as in Example 1. The experimental results are shown in Table 5.

TABLE 5

| | | | Tensile strength | | Length of |
|---|---|---|---|---|---|
| | | Outer | of wire material | Conductivity | nonlinear region |
| | Core wire | layer | for spring (MPa) | (% IACS) | (mm) |
| Example A | Steel type A | Copper plating | 2280 | 31 | 0.63 |
| Example H | Steel type A | Copper plating | 2296 | 16 | 0.64 |
| Example I | Steel type A | Copper plating | 2271 | 47 | 0.62 |

Referring to Table 5, it is evident that when wire materials for a spring are at the same tensile strength level, in spite of the fact that the conductivity changes in the range of 15% to 50%, the spring characteristic (length of the nonlinear region) does not change. This is the feature of the wire material for a canted coil spring according to the present application, which is never obtained in a copper alloy because of the trade-off relationship between strength and conductivity, and indicates that when the core wire and the outer layer are strongly joined together by plating, a large length of the nonlinear region can be obtained.

It should be understood that the embodiments and examples disclosed this time are illustrative and non-restrictive in all aspects. The scope of the present invention is not limited to the embodiments described above but is defined by the appended claims, and is intended to include all modifications within the meaning and scope equivalent to those of the claims.

### REFERENCE SIGNS LIST

1 wire material for a canted coil spring

2 canted coil spring

10 core wire

11 surface

20 plating layer

1. A wire material for a canted coil spring comprising:
a core wire made of steel with a pearlite structure; and
a plating layer covering a surface of the core wire and made of copper or a copper alloy,
wherein the steel contains 0.5% to 1.0% by mass of carbon, 0.1% to 2.5% by mass of silicon, and 0.3% to 0.9% by mass of manganese, with the balance being iron and unavoidable impurities.

2. The wire material for a canted coil spring according to claim 1, wherein the steel further contains at least one element selected from the group consisting of 0.1% to 0.4% by mass of nickel, 0.1% to 1.8% by mass of chromium, 0.1% to 0.4% by mass of molybdenum, and 0.05% to 0.3% by mass of vanadium.

3. The wire material for a canted coil spring according to claim 1, wherein the silicon content in the steel is 1.35% to 2.3% by mass.

4. The wire material for a canted coil spring according to claim 1, wherein the steel contains 0.6% to 1.0% by mass of carbon, 0.12% to 0.32% by mass of silicon, and 0.3% to 0.9% by mass of manganese, with the balance being iron and unavoidable impurities.

5. The wire material for a canted coil spring according to claim 1, wherein the steel contains 0.6% to 1.0% by mass of carbon, 0.7% to 1.0% by mass of silicon, and 0.3% to 0.9% by mass of manganese, with the balance being iron and unavoidable impurities.

6. The wire material for a canted coil spring according to claim 2, wherein the steel contains 0.55% to 0.7% by mass of carbon, 1.35% to 2.3% by mass of silicon, 0.3% to 0.9% by mass of manganese, 0.2% to 1.8% by mass of chromium, and 0.05% to 0.30% by mass of vanadium, with the balance being iron and unavoidable impurities.

7. The wire material for a canted coil spring according to claim 1, wherein the oxygen concentration at the interface between the core wire and the plating layer is 10% by mass or less.

8. The wire material for a canted coil spring according to claim 1, wherein the wire material for a canted coil spring has a tensile strength of 1,800 MPa to 2,500 MPa.

9. The wire material for a canted coil spring according to claim 1, wherein the wire material for a canted coil spring has a conductivity of 15% to 50% IACS.

10. The wire material for a canted coil spring according to claim 1, wherein the plating layer has a thickness of 10 μm to 65 μm.

11. The wire material for a canted coil spring according to claim 1, wherein the core wire has a diameter of 0.05 mm to 2.0 mm.

12. A canted coil spring made from the wire material for a canted coil spring according to claim 1.

13. A method of manufacturing a wire material for a canted coil spring comprising:
a step of preparing a core wire made of steel with a pearlite structure;
a step of forming a plating layer made of copper or a copper alloy so as to cover a surface of the core wire; and
a step of drawing the core wire provided with the plating layer,
wherein the steel contains 0.5% to 1.0% by mass of carbon, 0.1% to 2.5% by mass of silicon, and 0.3% to 0.9% by mass of manganese, with the balance being iron and unavoidable impurities.

14. The method of manufacturing a wire material for a canted coil spring according to claim 13, wherein the steel further contains at least one element selected from the group consisting of 0.1% to 0.4% by mass of nickel, 0.1% to 1.8% by mass of chromium, 0.1% to 0.4% by mass of molybdenum, and 0.05% to 0.3% by mass of vanadium.

15. The method of manufacturing a wire material for a canted coil spring according to claim 13, wherein the silicon content in the steel is 1.35% to 2.3% by mass.

16. The method of manufacturing a wire material for a canted coil spring according to claim 13, wherein the steel contains 0.6% to 1.0% by mass of carbon, 0.12% to 0.32% by mass of silicon, and 0.3% to 0.9% by mass of manganese, with the balance being iron and unavoidable impurities.

17. The method of manufacturing a wire material for a canted coil spring according to claim 13, wherein the steel contains 0.6% to 1.0% by mass of carbon, 0.7% to 1.0% by mass of silicon, and 0.3% to 0.9% by mass of manganese, with the balance being iron and unavoidable impurities.

18. The method of manufacturing a wire material for a canted coil spring according to claim 14, wherein the steel contains 0.55% to 0.7% by mass of carbon, 1.35% to 2.3% by mass of silicon, 0.3% to 0.9% by mass of manganese, 0.2% to 1.8% by mass of chromium, and 0.05% to 0.30% by mass of vanadium, with the balance being iron and unavoidable impurities.

19. A method of manufacturing a canted coil spring comprising:
a step of preparing a wire material for a canted coil spring which has been manufactured by the method of manufacturing a wire material for a canted coil spring according to claim 13; and
a step of coiling the wire material for a canted coil spring.

20. The method of manufacturing a canted coil spring according to claim 19, further comprising a step of heating the wire material for a canted coil spring which has been coiled to a temperature range of 250° C. to 400° C.
